(19) United States
(12) Patent Application Publication
(10) Pub. No.: US 2008/0022533 A1
(43) Pub. Date: Jan. 31, 2008

(54) HARVEST SHEAR

(75) Inventors: Karl H. Zeller, Portland, OR (US); Linn E. Nelson, Portland, OR (US)

Correspondence Address: PATENTTM.US, P. O. BOX 82788, PORTLAND, OR, 97282-0788, US

(73) Assignee: BARNEL INTERNATIONAL, INC., Portland, OR (US)

(21) Appl. No.: 11/775,195

(22) Filed: Jul. 9, 2007

Related U.S. Application Data
(60) Provisional application No. 60/806,781, filed on Jul. 8, 2006.

(51) Int. Cl. A01G 3/00

(52) U.S. Cl. 30/134; 56/1

(57) ABSTRACT

A harvest shear includes a finger ring portion to engage with a user's finger, such that the user can release grip on the shear, without the shear then falling away from the user's hand.

### BACKGROUND OF THE INVENTION

This invention relates to harvest tools, and more particularly to a pruner that is adapted for ease of use in the field, particularly for harvest of fruit, vegetable, flowers or the like.

Agricultural products, such as certain fruits, are typically harvested by cutting with a shear. Typical steps in harvest are: move the shear near the fruit stem; cut the stem while supporting the fruit with a second hand (to prevent the fruit from falling and being bruised or otherwise damaged); set the shear down; remove the fruit and place it in a container; pick the shear back up; and move to a next fruit for harvest. Over time the repeated motion of setting the shears down and picking them back up leads to increased fatigue for the user, as well as slowing down the harvest process. Further, typical shears are somewhat large and can be difficult to maneuver in tightly spaced fruit growing situations.

### SUMMARY OF THE INVENTION

In accordance with the invention, an improved harvest shear is provided that can be maintained in the user's hand, while enabling the user to handle and grasp the fruit without needing to drop or set down the shear.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a perspective view of the design for a PRUNER;

FIG. 2 is a front view of the harvest shear;

FIG. 3 is a right side view of the shear;

FIG. 4 is a rear elevational view of the shear;

FIG. 5 is a top view of the shear;

FIG. 6 is a left side view of the shear;

FIG. 7 is a bottom view of the shear;

FIG. 8 is a front view of a shear with curved blade;

FIG. 9 is a front view of a shear with needle nose style blade; and

FIG. 10 is a front view of a shear with a blunt nose shorter blade.

### DETAILED DESCRIPTION

According to a preferred embodiment of the present invention, a harvest shear adapted for ease of use in typical harvest conditions is provided.

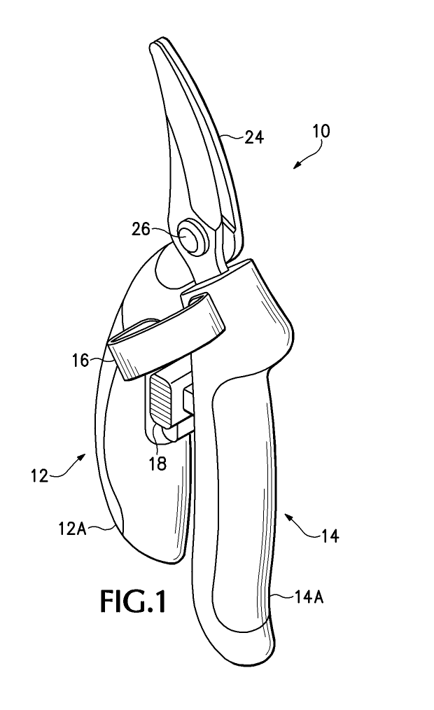

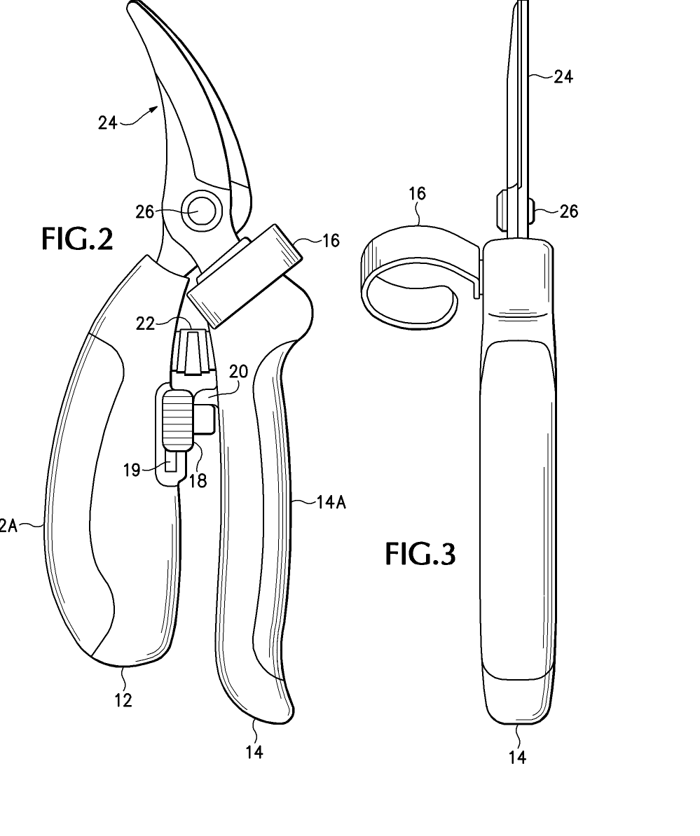

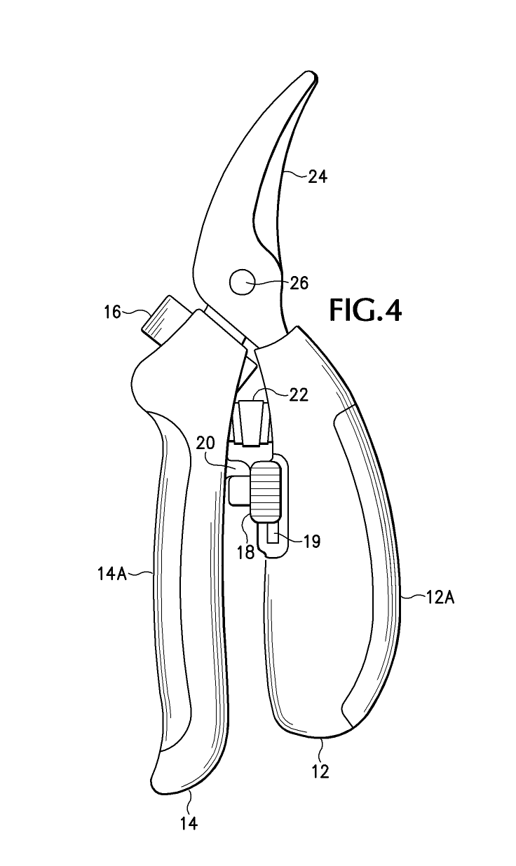

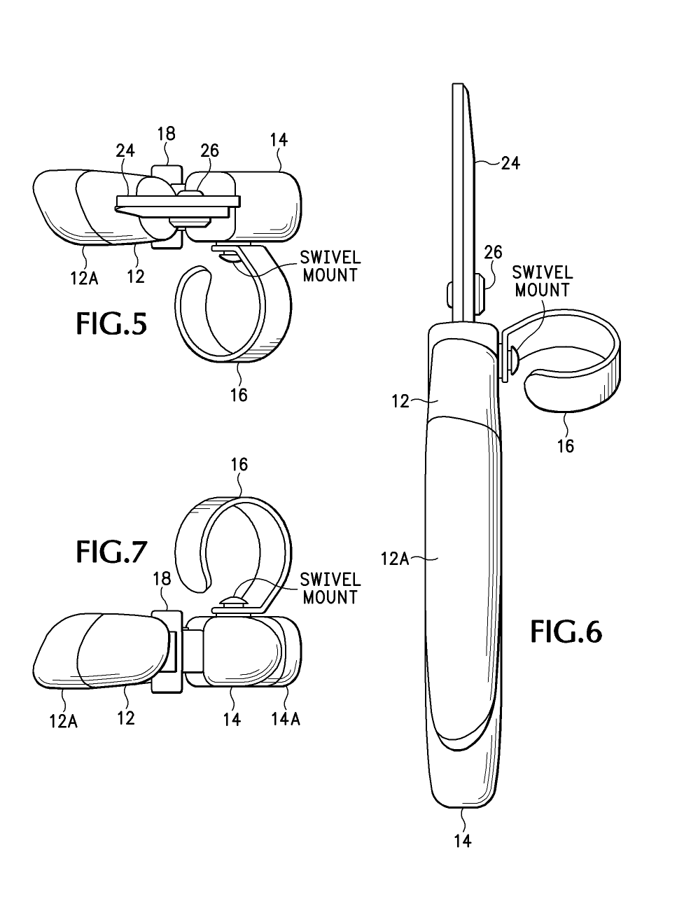

Referring to FIG. 1, a perspective view of the harvest shear, the shear employs first and second handles 12, 14, suitably constructed of ABS material with TPR (Thermoplastic Rubber) overlay. The TPR overly is provided as neoprene rubber handle portion 12A, 14A palm, to provide optimal grip control even in moist conditions that are often encountered in harvest conditions, whether environmental (e.g., weather, such as rain, dew, or from irrigation) or from sweat. The TPR provides greater control in moist conditions as well as adding to the overall ergonomic feel and performance of the shear.

Handle portion 14 is substantially smaller in cross sectional dimensions than handle portion 12, and is somewhat more straight in configuration in central portions thereof, to provide a region adapted for one or more of the users middle, ring and pinkie fingers to wrap therearound. Handle portion 12 is more bulbous and curvate in configuration to be comfortably received in the user's palm.

An open finger ring 16 is mounted to an upper end of handle 14, in a swivel configuration so that the ring can rotate to comfortably receive a user's index finger therethrough, for example. The ring is suitably a plastic coated metal, for example, adapted to be compressed to securely engage the user's finger in use, to help keep the harvest shear in the user's hand and reduce the possibility of field loss. Non-metal or all metal material may also be suitably used as the ring material.

A slide lock 18 is slidingly mounted to handle , and has a receiving aperture adapted to receive and engage a corresponding pin 20 mounted to handle 14. By sliding the lock 18 upwardly or downwardly along the length of the handle (slot 19 providing the guide along which the lock slides), the user can alternately lock or unlock the shear by movement of the user's thumb on the surface of the slide lock. The slide lock is a detent style, to provide a positive locking engagement/disengagement.

Spring 22, suitably a barrel spring in the particular illustrated embodiment, is provided to assist the blade to an open position when the user's hand opens. Other spring types or biasing mechanisms may also be employed.

The blade portion 24, comprising a left and right portion, is mounted to the upper end of handles 12 and 14, and are pivotally connected by bolt 26, such that operation of the shear by opening and closing the user's hand will open and close the blades to effect a cutting operation.

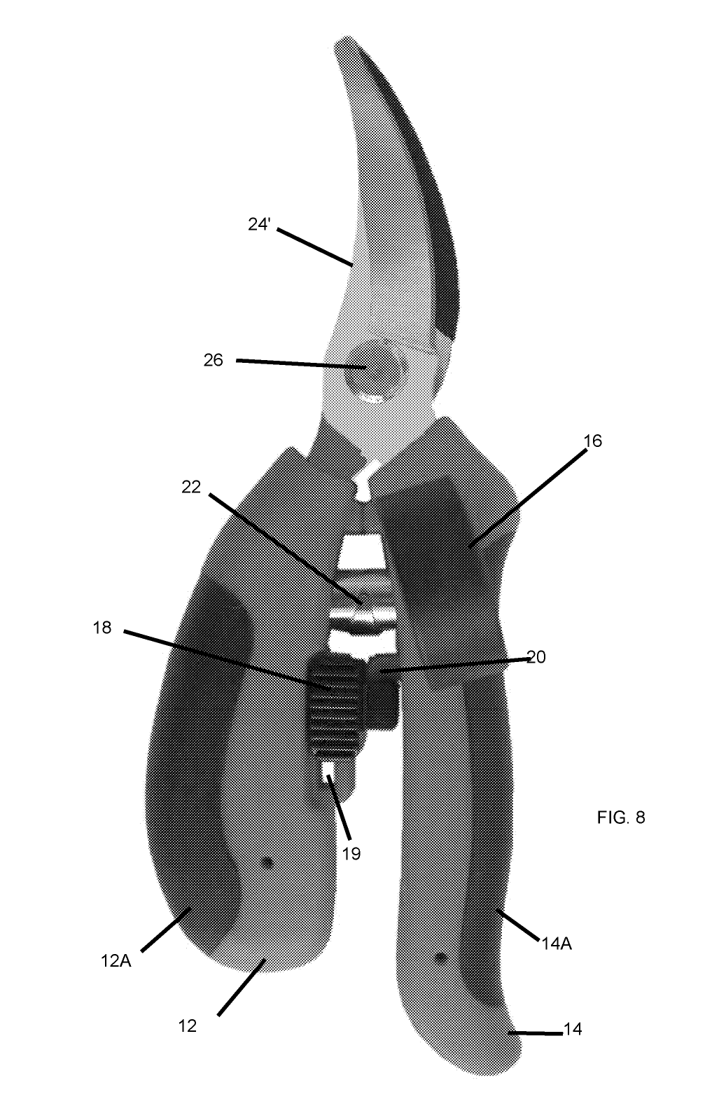

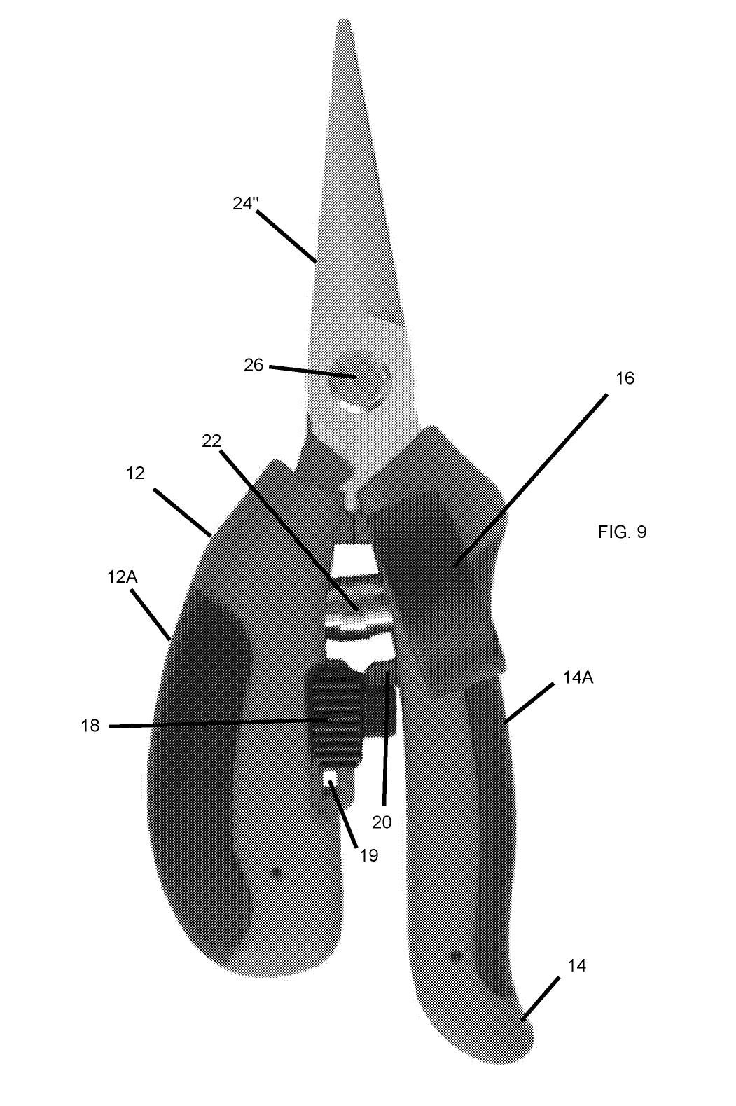

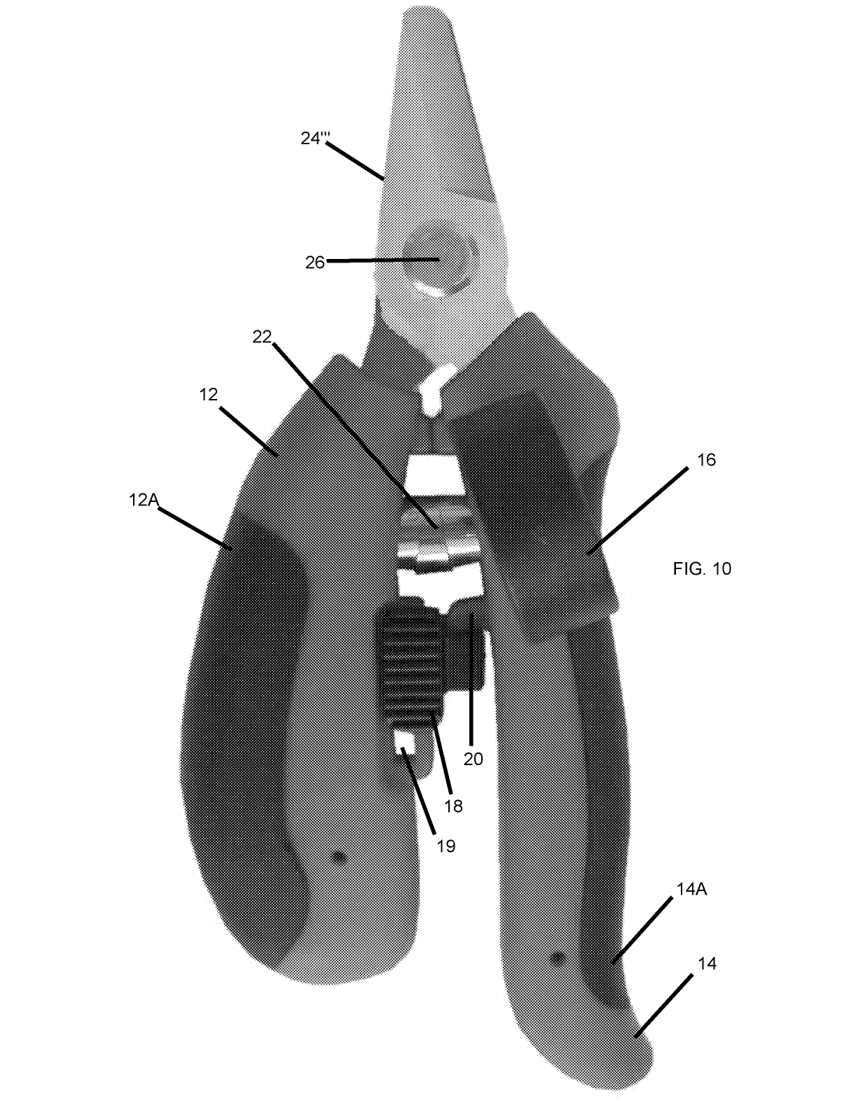

The blade 24′ is suitably curved in the embodiment illustrated (FIG. 8) to provide ease of access to fruit stems to be cut in harvesting, even in tight spacing conditions. Other embodiments can have differently curved blades, straight blades, pointed blades, needle nose blades 24″ (FIG. 9), blunt tip blades 24″′ (FIG. 10), whether short or long, for example.

In use, the harvester will hold the shear in the right hand (for the illustrated embodiment) placing the handle portion 12, 12A into the palm, passing the index finger into the ring 16 (swiveling the ring to allow the finger to pass through), and optionally compressing the ring somewhat to provide a secure engagement with the finger. The remaining fingers may be wrapped around handle portion 14, 14A, to enable opening and closing operation of the shear. The user's thumb is employed to lock or unlock the shear by sliding lock portion 18 either direction as desired.

After cutting the fruit stem, the user can let go of the shear handles, in order to be able to grasp the fruit. The ring 16 and its engagement with the index finger, will ensure that the shear remains in the user's hand, without falling to the ground. The user can then quickly begin cutting the next fruit stem when ready to, without having to reach for the shears as would be required in accordance with the prior art.

Accordingly, the harvest shear is provided with an adjustable finger hook (ring 16) to keep the shear in close relation to the user's hand, without requiring the user to maintain a constant grip on the shear.

The handles include portions that are very soft so as to be soft on the hands and in moist conditions, to provide better grip control.

The shear can be used as a one hand operation device, enabling the user to lock and unlock by movement of the thumb.

The shear therefore provides an ergonomic configuration adapted for long use in field, reducing user's tiring, removing the need to continually set the pruner down and pick it back up each time the user needs to employ the pruner hand to grasp the fruit, for example. The handle materials give good control in all weather conditions.

As noted above, the blades 24 may be made of steel, whether of high or low carbon steel or stainless steel, precision ground and heat treated for lasting blade sharpness. Other blade materials can be employed also. Use of stainless steel blades is desirable for use with harvest of table grapes, for example, to avoid any issues of carbon in the blade resulting in discoloration of the grapes.

The contour of the handle is such that it is adapted to be used for large and small hands, fitting comfortably in the palm of the user's hand.

The configuration enables it to fit in tight areas, for ease of harvest while minimizing the likelihood of damaging adjacent fruit.

Also, the finger ring (or ring clip) helps to reduce loss of the shear in the field since the shear need not be set aside in use, unlike with traditional shears.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A harvest shear, comprising:
a blade portion;
a handle portion; and
a finger engaging portion to secure the harvest shear to a user's hand.

2. The harvest shear according to claim 1, wherein said finger engaging portion comprises a ring adapted to receive a user's finger therein.

3. The harvest shear according to claim 2, wherein said finger engaging portion is rotatably attached to said handle portion, to enable adjustment thereof to accommodate finder position variations.

4. The harvest shear according to claim 2, wherein said handle portion comprises first and section handle members and said blade portion comprises first and second blade members operatively related to said handle members for open and close operation thereof to effect cutting operations.

5. The harvest shear according to claim 4, further comprising a lock member for latching the handles in a non-operative mode.

6. The harvest shear according to claim 1, wherein said handle portion comprises ABS material with TPR (Thermoplastic Rubber) overlay or insert.

7. The harvest shear according to claim 6, wherein said TPR overly is provided as a thermoplastic rubber handle portion.

8. The harvest shear according to claim 2, wherein said ring comprises a plastic coated metal.

9. The harvest shear according to claim 2, wherein said ring comprises metal.

10. The harvest shear according to claim 2, wherein said ring comprises plastic.

11. The harvest shear according to claim 2, wherein said ring is adapted to be compressed to securely engage a user's finger.

12. A method of harvesting, comprising:
holding a harvest shear in a user's hand,
placing a handle portion of the shear into the user's palm,
passing the user's index finger into a ring member portion of the harvest shear; and
operating the harvest shear to effect harvesting.

13. The method according to claim 12, further comprising swiveling the ring to align the ring to allow the user's finger to pass through.

14. The method according to claim 12, further comprising compressing the ring to provide a secure engagement with the finger.

15. The method according to claim 12, further comprising employing the user's thumb to lock or unlock a lock portion.

16. The method according to claim 12, wherein said operating said shear comprises cutting a fruit or vegetable stem, further comprising after cutting the stem, letting go the shear handles, grasping the fruit or vegetable, while retaining the shear in relation to the user's hand by action of the engagement between the ring and the user's finger.
